(19) United States
(12) Patent Application Publication
(10) Pub. No.: US 2008/0151471 A1
(43) Pub. Date: Jun. 26, 2008

(54) High voltage capacitor and method for manufacturing same

(75) Inventors: Etienne Savary, Farvagny (CH); Pierre Papaux, Farvagny (CH); Joseph Bulliard, Villarsel-le-Gibloux (CH); Cedric Scheidegger, Villeneure (CH)

Correspondence Address: ANATOLY S. WEISER, 3525 DEL MAR HEIGHTS ROAD, #295, SAN DIEGO, CA, 92130, US

(73) Assignee: Maxwell Technologies, Inc., San Diego, CA (US)

(21) Appl. No.: 11/644,505

(22) Filed: Dec. 22, 2006

(51) Int. Cl. H01G 4/04; H01G 4/00

(52) U.S. Cl. 361/312; 29/25.41; 361/327

(57) ABSTRACT

A high voltage capacitor includes multiple conductive strips on each side of a dielectric layer. The conductive strips on one side of the dielectric layer partially overlap conductive strips on the opposite side of the dielectric layer, in effect forming a series combination of subcapacitors. Insulating layers may overlay the conductive strips, sandwiching the strips between one of the insulating layers and the dielectric layer. To decrease the magnitude of the electric field between adjacent conductive strips on the same side of the dielectric layer, the gaps between the adjacent strips are filled with a dielectric liquid during the manufacturing process. The dielectric liquid may be, for example, aromatic oil, silicone oil, mineral oil, synthetic oil, a mixture of different oils, or a mixture of oil or oils with another substance. The resulting decrease in the magnitude of the electric field within the gaps reduces partial discharge in the capacitor.

### FIELD OF THE INVENTION

The present invention relates generally to capacitors and methods for making capacitors. More specifically, the present invention relates to high voltage capacitors and methods for making such capacitors.

### BACKGROUND

Capacitance of a given capacitor constructed with a pair of electrodes and a dielectric separator layer between the electrodes is roughly proportional to the overlapping area of the electrodes, and the dielectric constant (ε or “epsilon”) of the material from which the dielectric layer is made. The capacitance is also inversely proportional to the thickness of the dielectric layer. Thus, capacitance C may be expressed in terms of the overlapping area A, thickness d, and a proportionality constant K, as follows:

$$C = \frac{K \cdot ɛ \cdot A}{d} .$$

A capacitor's breakdown voltage depends on the thickness d of the dielectric layer. The thicker the layer, the higher the breakdown voltage. It follows that while decreasing the thickness d increases capacitance, there is a practical limit to how thin the dielectric layer can be made for a specified breakdown voltage.

FIG. 1 shows a cross-section of a high voltage capacitor cell 100. In the capacitor cell 100, conducting strips 110a-110f are disposed on one side of a dielectric layer 130, and conducting strips 120a-120f are disposed on the other side of the dielectric layer 130. An insulating layer 140 overlays the strips 110, and another insulating layer 150 overlays the strips 120. The end strip 110a is connected to a first external electrical terminal (not shown) of the capacitor cell 100, and the end strip 120f is connected to the second external electrical terminal (also not shown) of the capacitor cell 100. (Alternatively, the external electrical terminals may be connected to the end strips 110f and 120a.) The other strips are not connected to each other or to the external terminals. It should be noted that the cross-section shown in FIG. 1 was taken along a plane transverse to the longitudinal dimension of the conducting strips 110 and 120.

The capacitor architecture or structure shown in FIG. 1 may be referred to as “multi-strip” architecture or structure.

Each of the strips 110 (with the possible exception of the end strips 110f and 120a) partially overlaps two strips 120, in effect forming two capacitors in series with each other. FIG. 4 illustrates the electrical equivalent circuit of the physical construct of FIG. 1. As is illustrated in FIG. 4, eleven subcapacitors make up the capacitor cell 100. The subcapacitors are designated as Cₐₐ, C_{ab}, C_{bb}, C_{bc}, C_{cc}, C_{cd}, C_{dd}, C_{de}, Cₑₑ, C_{ef}, and C_{ff}. In this notation, the first suffix designates the 120 strip that effectively forms one electrode of the subcapacitor, and the second suffix designates the 110 strip that forms the other electrode of the subcapacitor.

The subcapacitors are connected in series, so that any terminal voltage Vₜ between the end terminals of the capacitor cell 100 is divided among the subcapacitors, as is well known to those skilled in the art. If each of the subcapacitors has substantially the same capacitance, then the voltage across each subcapacitor is approximately one-eleventh of Vₜ. The breakdown voltage of each subcapacitor is generally determined by the dielectric material used for the dielectric layer 130 and the thickness of the dielectric layer 130. Whatever the breakdown voltage of the dielectric layer 130 given its thickness d, the breakdown voltage of the capacitor cell 100 is approximately eleven times higher, because of the division of the terminal voltage Vₜ among the eleven subcapacitors Cₐₐ through C_{ff}. This scheme allows the capacitor cell 100 to have a relatively high breakdown voltage rating, achieved at the cost of lower capacitance.

The potential difference between adjacent strips on the same side of the layer 130 (for example, the potential difference between the strips 110b and 110c, or the potential difference between the strips 120d and 120e) is twice the voltage appearing across each of the subcapacitors. (Here and throughout this document we adhere to the assumption that all the subcapacitors of a capacitor (or capacitor cell) have approximately the same capacitance; this is done for simplicity and is not necessarily a requirement of the invention.) The increased potential difference across the gaps 160 elevates the magnitude of the electric filed in the gaps 160. Furthermore, because the dielectric constant of the unfilled gaps 160 formed in between the strips 110 and in between the strips 120 is lower than that of the dielectric material of the layer 130, the electric field in the gaps 160 is still higher. There may also be some fringing effects at the edges of the strips 110 and 120, further contributing to the increase in the electric field. Thus, arcing may take place across the gaps 160.

Partial discharge (PD) effect may also take place in the portions of the dielectric layer 130 bordering the gaps 160 formed between adjacent strips 110 and/or 120. Partial discharge is dielectric breakdown localized to a small portion of electrical insulation, such as the dielectric layer 130. Partial discharge takes place because of the stress of electrical voltage. Partial discharge is progressive, causing deterioration of the dielectric material. In the end, partial discharge may cause complete breakdown of the dielectric material. Thus, partial discharge is a problem in high voltage capacitors. Partial discharge may become a particular problem within the portions of the dielectric layer 130 that are near the gaps 160.

It would be desirable to prevent or reduce incidents of arcing and partial discharge in high voltage capacitors, including high voltage capacitors of the general architecture shown in FIG. 1.

### SUMMARY

A need thus exists for high voltage capacitors with reduced vulnerability to internal arcing and partial discharge. A need also exists for methods of making high voltage capacitors with reduced vulnerability to internal arcing and partial discharge.

Various embodiments of the present invention are directed to high voltage capacitor cells. In one embodiment, a capacitor cell includes a dielectric layer, a first plurality of parallel conducting strips disposed on the first side of the dielectric layer, and a second plurality of parallel conducting strips disposed on the second side of the dielectric layer. One or more first gaps are formed between adjacent conducting strips of the first plurality of parallel conducting strips, and one or more second gaps are formed between adjacent conducting strips of the second plurality of parallel conducting strips. The conducting strips of the second plurality of conducting strips are parallel to the conducting strips of the first plurality of conducting strips, so that the first gaps and the second gaps are also parallel. A dielectric liquid fills the first gaps and the second gaps.

In aspects of the invention first and second insulating layers are also provided. The first insulating layer overlays the first plurality of strips so that the strips of the first plurality of strips are disposed between the dielectric layer and the first insulating layer. Similarly, the second insulating layer overlays the second plurality of strips so that the strips of the second plurality of strips are disposed between the dielectric layer and the second insulating layer.

Various embodiments of the present invention are also directed to methods of making capacitor cells. In one such method embodiment, a method includes the following steps: (1) providing a dielectric layer with a first surface and a second surface, (2) disposing a first plurality of parallel conducting strips on the first surface of the dielectric layer, (3) disposing a second plurality of parallel conducting strips on the second surface of the dielectric layer, and (3) filling the one or more first gaps and the one or more second gaps with a dielectric liquid. One or more first gaps are formed between adjacent conducting strips of the first plurality of parallel conducting strips, and one or more second gaps are formed between adjacent conducting strips of the second plurality of parallel conducting strips. Furthermore, the conducting strips of the second plurality of conducting strips are parallel to the conducting strips of the first plurality of conducting strips, so that the first gaps run parallel to the second gaps.

These and other features and aspects of the present invention will be better understood with reference to the following description, drawings, and appended claims.

### BRIEF DESCRIPTION OF THE FIGURES

FIG. 1 illustrates a cross-section of a high voltage capacitor cell having multi-strip structure;

FIG. 2A illustrates a cross section of a high voltage capacitor cell having multi-strip structure, in accordance with selected aspects of the present invention;

FIG. 2B illustrates a cross section of a high voltage capacitor cell having multi-strip structure and multiple films of dielectric layer, in accordance with selected aspects of the present invention;

FIG. 3 illustrates the process of applying dielectric liquid (e.g., oil) to the inter-strip gaps of a capacitor with multi-strip structure, in accordance with selected aspects of the present invention; and

FIG. 4 illustrates electrical equivalent circuit of the capacitor cells shown in FIGS. 1, 2A, and 2B.

### DETAILED DESCRIPTION

In this document, the words “embodiment” and “variant” refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity. Characterization of an embodiment as “exemplary” means that the embodiment is used as an example. Such characterization does not necessarily mean that the embodiment is a preferred embodiment; the embodiment may but need not be a currently preferred embodiment.

The words “couple,” “connect,” and similar expressions with their inflectional morphemes do not necessarily import an immediate or direct connection, but include connections through mediate elements within their meaning.

A “capacitor” may include a single capacitor cell, or it may include multiple capacitor cells connected in parallel, in series, or in both parallel and series combinations.

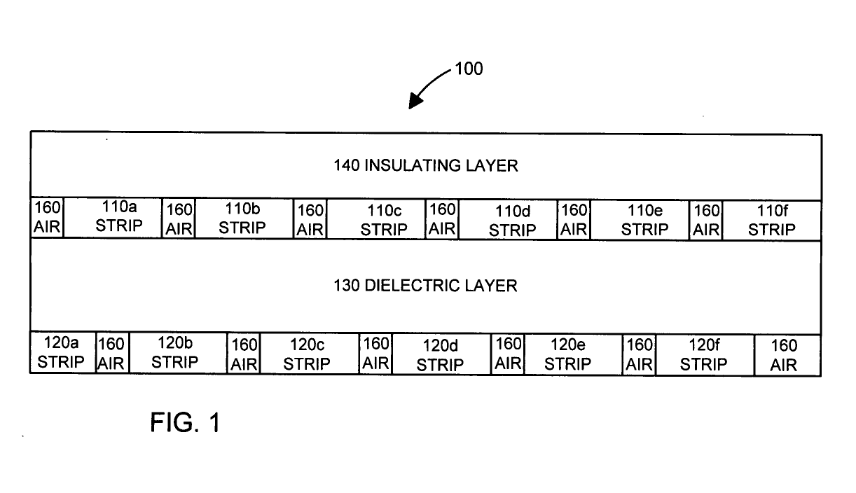

A “subcapacitor” is a capacitor formed between partially overlapping conducting strips on opposite sides of a dielectric layer of a high voltage capacitor having multi-strip structure. The meaning of subcapacitor is further clarified by FIGS. 1, 2A, and 4, and the description of these Figures.

Other and further definitions and clarifications of definitions may be found throughout this document. All the definitions are intended to assist in understanding this disclosure and the appended claims, but the scope and spirit of the invention should not necessarily be construed as strictly limited to the definitions, or to the particular examples described in this specification.

In accordance with broad principles of the present invention, gaps between strips of metallization on the same side of a dielectric layer of a multi-strip capacitor structure are filled with a dielectric liquid during the manufacturing process. The liquid may be oil, for example, aromatic oil, silicone oil, mineral oil, synthetic oil, other oil, a mixture of different oils, or a mixture of one or more oils with another substance.

Reference will now be made in detail to several embodiments of the invention that are illustrated in the accompanying drawings. Same reference numerals may be used in the drawings and the description to refer to the same components or steps. The drawings are in simplified form and not to precise scale. For purposes of convenience and clarity only, directional terms, such as top, bottom, left, right, up, down, over, under, above, below, beneath, rear, and front may be used with respect to the accompanying drawings. These and similar directional terms should not be construed to limit the scope of the invention.

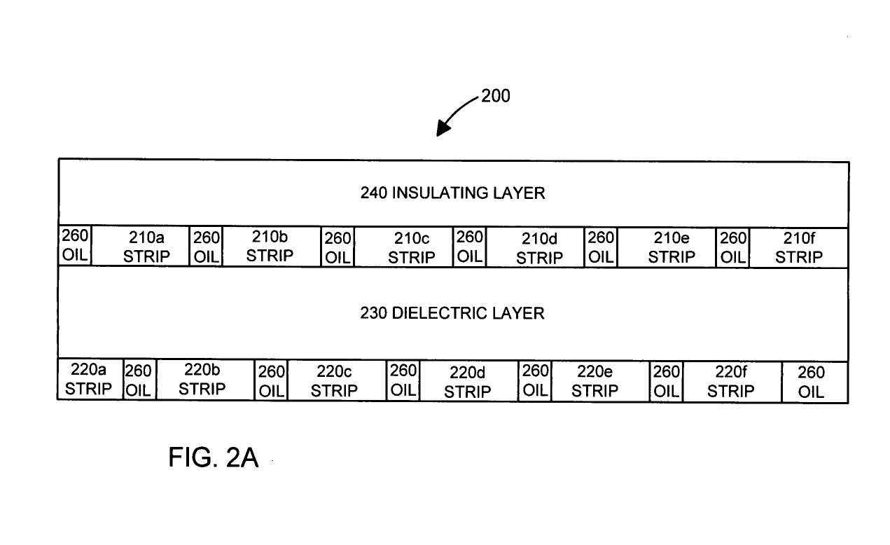

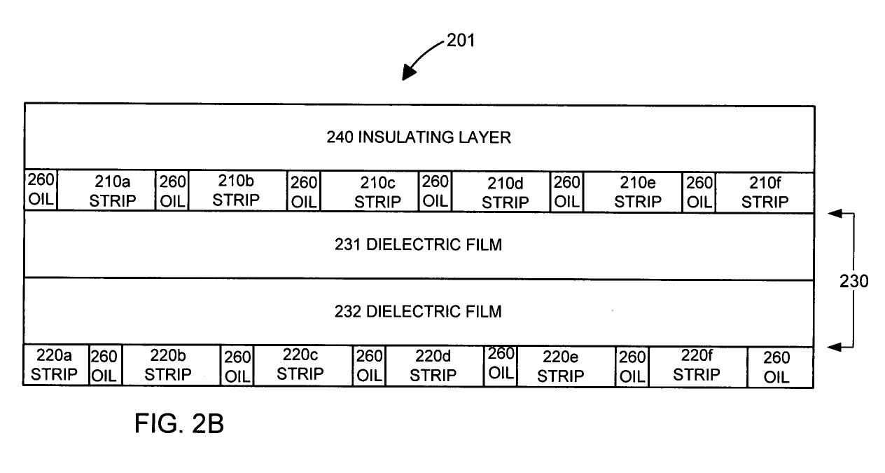

Referring more particularly to the drawings, FIG. 2A illustrates a cross-section of a high voltage capacitor cell 200. This cross-section is similar in appearance to the cross-section of the high voltage capacitor cell 100 illustrated in FIG. 1, and the components of the capacitor cell 200 shown in FIG. 2 are designated similarly to the analogous components of the capacitor cell 100 shown in FIG. 1, with the leading digit “2” replacing the leading digit “1” in component reference numerals. In the capacitor cell 200, conducting strips 210a-210f are disposed on one side of a dielectric layer 230, and conducting strips 220a-220f are disposed on the other side of the dielectric layer 230. An insulating layer 240 overlays the strips 210, and another insulating layer 250 overlays the strips 220. The end strip 210a is connected to a first external electrical terminal (not shown) of the capacitor cell 200, and the end strip 220f is connected to a second external electrical terminal (also not shown) of the capacitor cell 200. The other strips are not connected to each other or to the external terminals. As in the case of FIG. 1, the cross-section was taken along a plane that is transverse to the longitudinal dimension of the conducting strips.

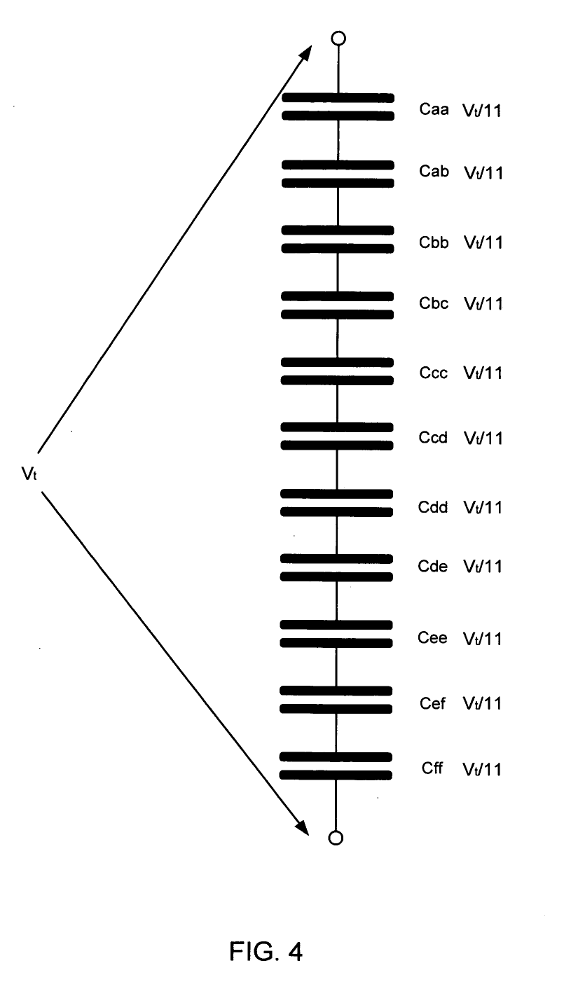

Because of the structural similarity of the capacitor cells 100 and 200, the equivalent circuit of FIG. 4 also represents the electrical equivalent of the physical construct of FIG. 2. Thus, the eleven subcapacitors designated as Cₐₐ, C_{ab}, C_{bb}, C_{bc}, C_{cc}, C_{cd}, C_{dd}, C_{de}, Cₑₑ, C_{ef}, and C_{ff} make up the capacitor cell 200. In this notation, the first suffix of a given subcapacitor designates the 220 strip that effectively forms one electrode of the subcapacitor, and the second suffix of the subcapacitor designates the 210 strip that forms the other electrode of the same subcapacitor.

Note the presence of gaps 260 formed in between the adjacent strips 210 and in between the adjacent strips 220. Unlike the case of the capacitor cell 100 and its gaps 160, here the gaps 260 are filled or substantially filled with a dielectric liquid. In some variants, each of the gaps 260 is at least seventy-five percent filled with the dielectric liquid, on average. In more specific variants, each of the gaps 260 is at least ninety percent filled with the dielectric liquid, on average. In yet more specific variants, each of the gaps 260 is at least ninety-five percent filled with the dielectric liquid, on average. In some variants, each gap 260 of a majority of the gaps 260 on each side of the dielectric layer 230 is at least seventy-five, ninety, or ninety-five percent filled with the dielectric liquid, on average. The averages are measured by volume and taken over the effective length of the strips defining the particular gap

In some embodiments, the dielectric material filling the gaps 260 is oil. In variants, the oil may be aromatic oil, silicone oil, mineral oil, synthetic oil, combinations of these oils, and combinations of one or more of these oils with other liquids or powders.

Aromatic oils are blended synthetic aroma compounds, or natural essential oils. Such blends are diluted with a carrier. Diluting carriers may be selected, for example, from propylene glycol, vegetable oil, or mineral oil. Many aromatic oils have a benzene ring (C₆H₆) in the formulation.

Essential oils, also known as ethereal and volatile oils, are hydrophobic liquids with volatile aromatic compounds extracted from plants. There are a number of ways to make such oils, including solvent extraction, distillation, and expression. Essential oils include vegetable oils, such as rapeseed oil. Canola oil is one variety of rapeseed oil with low erucic acid content. Rapeseed oil made from other cultivars and other essential oils are not excluded from use in the invention.

In some variants, the essential oils used in the invention are substantially without presence of aromatic compounds. For example, aromatic compounds are not intentionally introduced into the oil, but trace amounts of aromatic compounds may still be present in such oils.

Mineral oils are also known as liquid petrolatum. They are generated in the process of distillation of crude oil into gasoline. In general, mineral oils are chemically inert, transparent, and colorless. Their main ingredients are alkanes and cyclic paraffins. Mineral oil viscosities can vary within broad ranges, from relatively light to relatively heavy grades.

Synthetic oils possess certain desirable properties, including dielectric constant that is close to that of polypropylene. On the negative side, synthetic oils tend to be more aggressive than other oils, causing increased corrosion of many conducting materials that are suitable for use in the strips 210 and 220, including zinc and aluminum. In a specific variant, polyester oil polymerized at low temperature is used.

As in the case of other oils used in high voltage applications, and particularly in high voltage capacitor applications, it is desirable to reduce moisture content of the oil used for filling the gaps 260. In some variants, moisture content of the oil is no more than 40 parts per million (ppm). In certain more specific variants, moisture content is held to 30 ppm or less. In yet more specific variants, moisture content of the oil is no greater than 15 ppm. It may also be preferable to control acidic content of the oil. Generally, oils that meet production specifications for use in high voltage capacitors are suitable for use in accordance with the present invention. Preferably, corrosive sulphur content is held to a minimum so that the oil is essentially non-corrosive.

One desirable property of the oil used in the invention is the oil's ability to absorb hydrogen, because hydrogen tends to be released from the polymer that may be used in the dielectric layer 230 and/or insulating layers 240 and 250.

Another desirable property of the oil is a relatively high dielectric constant, for example, a dielectric constant approximating that of the dielectric layer 230. A relatively high dielectric constant of the oil prevents increased electric field intensity within the gaps 260 filled with the oil. In some embodiments, the dielectric constant of the dielectric layer 230 is between 2.2 and 3.0. (Throughout this document we refer to the relative dielectric constants, rather than absolute dielectric constants, as measured at the intended frequency of operation of the capacitor, such as 50 or 60 Hertz.) The dielectric constant of the oil or another liquid used for filling the gaps 260 may lie within the same range, e.g., between 2.2 and 3.0. In some variants, the dielectric constant of the liquid is within twenty percent of the dielectric constant of the layer 230. In certain more specific variants, the dielectric constant of the liquid is within ten percent of the dielectric constant of the layer 230.

Still another desirable property of the oil is relatively low viscosity, to allow the oil to fill the gaps 260 and substantially to prevent the oil from being caught between the strips 210/220 and the dielectric layer 230, or reduce the amount of oil caught between the strips 210/220 and the layer 230. In some variants, the viscosity of the oil is less than 12.0 mm²/s at 40 degrees centigrade.

Yet another desirable property of the oil is low loss factor, or tangent delta, at frequencies of interest. In some variants, tangent delta of the oil used to fill the gaps 260 is 0.005 or less at 50 and 60 Hertz and 90 degrees Centigrade. In some more specific variants, tangent delta off the oil is 0.001 or less at the same frequencies and temperature.

Other desirable properties of the oil include a low thermal expansion coefficient, high thermal conductivity, and high breakdown voltage.

In some specific variants, the dielectric liquid used in the capacitor cell 200 is selected from compositions sold under the name Jarylec® (e.g., Jarylec C100 and C101), available from ELF ATOCHEM, S.A. CORPORATION FRANCE LA DEFENSE 10 4 COURS MICHELET CEDEX 42, 92091 PARIS, FRANCE. Jarylec® is a blend of phenyl-tolylmethane and phenyl/benzyl-tolylmethane. In certain other specific variants, Wemcol™ dielectric liquid (isopropylbiphenyl) is used. Wemcol™ is marketed by Westinghouse corporation.

The dielectric layer 230 may include a single dielectric film, as is shown in FIG. 2A, or the layer 230 may be made with multiple dielectric films. Films made from certain dielectrics tend to have holes extending substantially or completely through their widths, thus making breakdown, increased current leakage, and partial discharge more likely. When two such films are placed next to each other, the likelihood of such holes overlapping is greatly reduced compared to the likelihood of occurrence of a through hole in a single film. Additional layers make occurrence of overlapping holes still less likely. Therefore, selected embodiments implement the dielectric layer 230 with multiple films. Each of the multiple films used in a capacitor cell may be made from the same predetermined material and have the same predetermined thickness, or the materials and thicknesses may differ.

A film used in the dielectric layer 230 (either the only film or one of two or more films) may be made with polypropylene, paper, or another dielectric. In some embodiments, the dielectric layer 230 includes one polypropylene film and a sheet of paper. In some embodiments, the dielectric layer 230 is made from a single sheet of paper sandwiched between two polypropylene films that are substantially identical in thickness and in composition. In still other embodiments, only polypropylene sheets are used. For example, two, three, or a higher number of polypropylene films are used for the layer 230, without intervening paper sheets. Each of the multiple polypropylene films may have substantially the same predetermined thickness and the same predetermined composition. Alternatively, thicknesses and compositions may vary from film to film within the dielectric layer 230.

Polymers other than polypropylene may also be used in the dielectric layer 230.

The insulating layers 240 and 250 may be made of the same materials as the dielectric layer 230, e.g., polypropylene, other polymers, paper, and similar materials. The layers 240 and 250 may be substantially identical in composition and thickness, or they may differ in either of these parameters. Either one or even both of these layers may be absent from specific embodiments.

Turning next to the conducting strips 210 and 220, they may be composed of aluminum, zinc, other metals, various metal alloys, including alloys of aluminum with zinc, or other conducting materials. The strips may be deposited on the opposite sides of the dielectric layer 230, whether the dielectric layer 230 is composed of a single film or multiple films. Similarly, the strips 210 may be deposited on the insulating layer 240, and the strips 220 may be deposited on the insulating layer 250. In some variants, the strips have thickness between 100 and 1,500 Angstroms. Spraying is used in some process embodiments for depositing metal of the conducting strips 210 and 220. Alternatively, the conducting strips 210 and 220 may be foil applied to the appropriate surfaces of the dielectric layer 230 and/or insulating layers 240 and 250. The foil may be aluminum foil approximately five micrometers in thickness. For example, the foil may be between four and seven micrometers in thickness.

As has already been mentioned, the dielectric layer 230 may be composed of a single film or multiple films. For completeness, FIG. 2B illustrates a capacitor cell 201 in which the dielectric layer 230 is composed of a first dielectric film 231 and a second dielectric film 232. Other embodiments include capacitor cells in which the dielectric layer is composed of three and higher numbers of films.

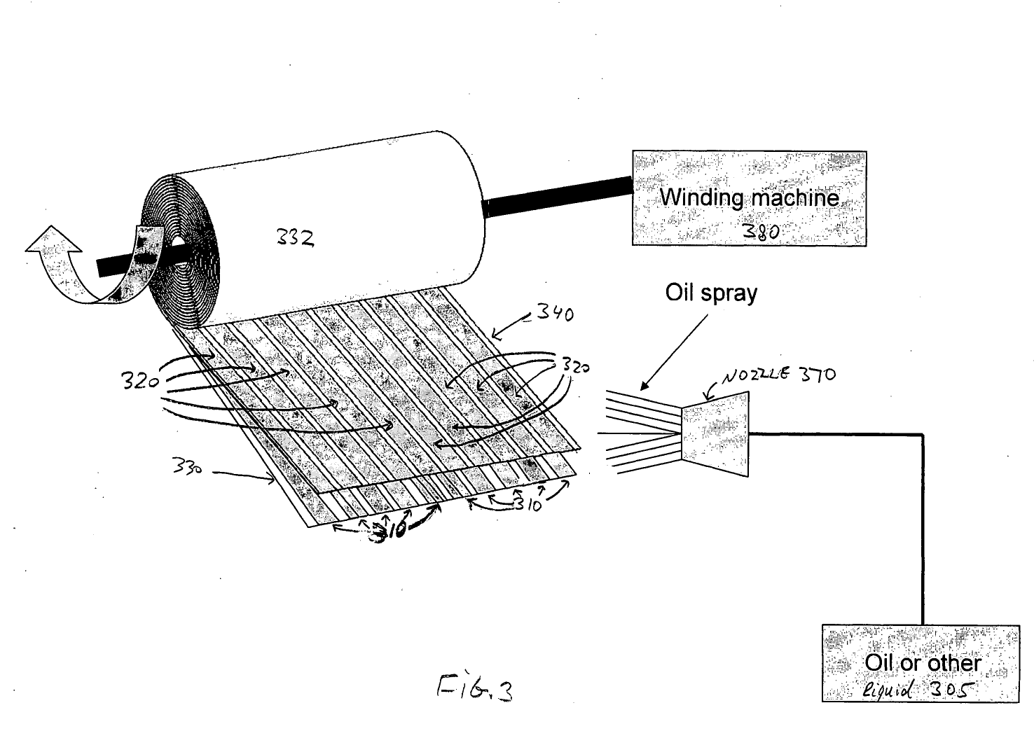

Application of the oil or another dielectric liquid to the gaps 260 may be done in a variety of ways. FIG. 3 illustrates spraying of oil or other liquid 305 through a nozzle 370 onto polypropylene sheets 330 and 340 having thereon conductive strips 310 and 320, respectively. One of the polypropylene sheets (e.g., the sheet 330) may be a dielectric layer of a capacitor cell, similar to the dielectric layer 230; the second sheet (e.g., 340) may be an insulation layer of the same capacitor cell, similar to the insulating sheet 240 or 250. A winding machine 380 advances the sheets 330 and 340 by winding them at a constant speed onto a roll 332. A jellyroll of a capacitor cell is thus formed.

The oil or another dielectric liquid may also be applied by brushing it between conductive strips deposited onto the dielectric layer, or by pulling the dielectric layer with the conductive strips through a bath filled with the dielectric liquid. Other liquid application method may be used as well.

After a jellyroll is formed and the inter-strip gaps are filled with the dielectric liquid, selected conducting strips (e.g., one end strip on each side of the dielectric layer) may be connected to external terminals, and the jellyroll may then be inserted into and sealed within a housing to form a high voltage capacitor or a high voltage capacitor cell.

As one alternative to a jellyroll, the dielectric layer with the conducting strips and the insulating layers may be folded to form a flat capacitor core, and then inserted into and sealed within an appropriate housing, such as the capacitor cells shown in the commonly-assigned U.S. patent application Ser. No. 11/016,434. The disclosure of that patent application is hereby incorporated by reference, including all Figures and claims.

The inventive high voltage capacitors, capacitor cells, and method of their manufacture have been described above in considerable detail. This was done for illustration purposes. Neither the specific embodiments of the invention as a whole, nor those of its features, limit the general principles underlying the invention. In particular, the invention is not necessarily limited to the specific dielectric liquids or dielectric films mentioned. The invention is also not necessarily limited to the specific liquid application methods described, or to the number of conductive strips shown in the Figures. The specific features described herein may be used in some embodiments, but not in others, without departure from the spirit and scope of the invention as set forth. Many additional modifications are intended in the foregoing disclosure, and it will be appreciated by those of ordinary skill in the art that, in some instances, some features of the invention will be employed in the absence of a corresponding use of other features. The illustrative examples therefore do not define the metes and bounds of the invention and the legal protection afforded the invention, which function is served by the claims and their equivalents.

We claim:

1. A capacitor cell, comprising:
a dielectric layer comprising a first side and a second side;
a first plurality of parallel conducting strips disposed on the first side of the dielectric layer, wherein one or more first gaps are formed between adjacent conducting strips of the first plurality of parallel conducting strips;
a second plurality of parallel conducting strips disposed on the second side of the dielectric layer, the conducting strips of the second plurality of conducting strips being parallel to the conducting strips of the first plurality of conducting strips, wherein one or more second gaps are formed between adjacent conducting strips of the second plurality of parallel conducting strips; and
a dielectric liquid filling the one or more first gaps and the one or more second gaps.

2. A capacitor cell according to claim 1, further comprising:
a first insulating layer overlaying the first plurality of strips so that the strips of the first plurality of strips are disposed between the dielectric layer and the first insulating layer; and
a second insulating layer overlaying the second plurality of strips so that the strips of the second plurality of strips are disposed between the dielectric layer and the second insulating layer.

3. A capacitor cell according to claim 2, wherein the dielectric liquid comprises oil.

4. A capacitor cell according to claim 2, wherein the dielectric liquid comprises an aromatic oil.

5. A capacitor cell according to claim 2, wherein the dielectric liquid comprises an essential oil.

6. A capacitor cell according to claim 2, wherein the dielectric liquid comprises a mineral oil.

7. A capacitor cell according to claim 2, wherein the dielectric liquid comprises silicone oil.

8. A capacitor cell according to claim 2, wherein the dielectric liquid comprises synthetic oil.

9. A capacitor cell according to claim 2, wherein the dielectric liquid comprises propylene glycol.

10. A capacitor cell according to claim 2, wherein the dielectric liquid comprises a mixture of at least two different oils.

11. A capacitor cell according to claim 2, wherein the dielectric liquid has a relative dielectric constant between about 2.2 and 3.

12. A capacitor cell according to claim 2, wherein:
the dielectric layer has a first relative dielectric constant between about 2.2 and 3; and
the dielectric liquid has a second relative dielectric constant between about 2.2 and 3.

13. A capacitor cell according to claim 2, wherein:
the dielectric layer has a first relative dielectric constant;
the dielectric liquid has a second relative dielectric constant; and
the second relative dielectric constant is within ten percent of the first relative dielectric constant.

14. A capacitor cell according to claim 2, wherein:
the dielectric layer has a first relative dielectric constant;
the dielectric liquid has a second relative dielectric constant; and
the second relative dielectric constant is within twenty percent of the first relative dielectric constant.

15. A capacitor cell according to claim 2, wherein the dielectric layer comprises a polymer.

16. A capacitor cell according to claim 2, wherein the dielectric layer comprises polypropylene.

17. A capacitor cell according to claim 2, wherein the dielectric layer comprises a plurality of polymer films.

18. A capacitor cell according to claim 2, wherein the dielectric layer comprises a polymer film and at least one paper sheet.

19. A capacitor cell according to claim 2, wherein the dielectric layer comprises a plurality of polymer films and at least one paper sheet.

20. A capacitor cell according to claim 2, wherein the conductive strips of the first and second pluralities are between four and seven micrometers in thickness.

21. A capacitor cell according to claim 2, wherein each gap of the first gaps and the second gaps is on average at least seventy-five percent filled with the dielectric liquid.

22. A capacitor cell according to claim 2, wherein each gap of the first gaps and the second gaps is on average at least ninety percent filled with the dielectric liquid.

23. A capacitor cell according to claim 2, wherein each gap of the first gaps and the second gaps is on average at least ninety-five percent filled with the dielectric liquid.

24. A capacitor cell according to claim 2, wherein each first gap of a majority of the first gaps is on average at least ninety-five percent filled with the dielectric liquid, and each second gap of a majority of the second gaps is on average at least ninety-five percent filled with the dielectric liquid.

25. A capacitor cell according to claim 2, wherein the liquid comprises oil with moisture content of 15 parts per million (ppm) or less.

26. A capacitor cell according to claim 2, further comprising:
a first terminal electrically coupled to a first conductive strip of the first plurality of parallel conducting strips;
a second terminal electrically coupled to a second conductive strip of the second plurality of parallel conducting strips; and
an enclosure;
wherein the first plurality of parallel conducting strips, the second plurality of parallel conducting strips, the dielectric layer, the first insulating layer, and the second insulating layer are disposed within the enclosure.

27. A method of making a capacitor cell, comprising:
providing a dielectric layer comprising a first surface and a second surface;
disposing a first plurality of parallel conducting strips on the first surface of the dielectric layer, wherein one or more first gaps are formed between adjacent conducting strips of the first plurality of parallel conducting strips;
disposing a second plurality of parallel conducting strips on the second surface of the dielectric layer, wherein the conducting strips of the second plurality of conducting strips are parallel to the conducting strips of the first plurality of conducting strips, and one or more second gaps are formed between adjacent conducting strips of the second plurality of parallel conducting strips; and
filling the one or more first gaps and the one or more second gaps with a dielectric liquid.

28. A method according to claim 27, wherein the step of filling comprises spraying the one or more first gaps and the one or more second gaps with oil.

29. A method according to claim 27, wherein the step of filling comprises brushing oil into the one or more first gaps and the one or more second gaps.

30. A method according to claim 27, wherein the step of filling comprises, after the steps of disposing the first and second pluralities of parallel conducting strips, pulling the dielectric layer through a bath filled with oil.

31. A method according to claim 27, wherein the step of providing the dielectric layer comprises providing a plurality of dielectric films.
